(19) United States
(12) Patent Application Publication
(10) Pub. No.: US 2021/0229029 A1
(43) Pub. Date: Jul. 29, 2021

(54) SELECTIVELY PERMEABLE GRAPHENE OXIDE MEMBRANE

(71) Applicant: NITTO DENKO CORPORATION, Osaka (JP)

(72) Inventors: Shijun Zheng, San Diego, CA (US); Isamu Kitahara, San Diego, CA (US); Yuji Yamashiro, Osaka (JP); Weiping Lin, Carlsbad, CA (US); John Ericson, Poway, CA (US); Wanyun Hsieh, San Diego, CA (US); Ozair Siddiqui, Murrieta, CA (US); Peng Wang, San Diego, CA (US); Craig Roger Bartels, San Diego, CA (US); Makoto Kobuke, Osaka (JP); Shunsuke Noumi, Shiga (JP); Hiroki Fujioka, Osaka (JP); Bita Bagge, Vista, CA (US)

(21) Appl. No.: 15/734,498

(22) PCT Filed: Aug. 3, 2018
(86) PCT No.: PCT/US2018/045186

§ 371 Date: Dec. 2, 2020

Related U.S. Application Data
(60) Provisional application No. 62/682,397, filed on Jun. 8, 2018.

(51) Int. Cl. B01D 53/22; B01D 71/02; B01D 71/38; B01D 69/12; B01D 53/26; B01D 67/00; B01D 69/02

(52) U.S. Cl. CPC B01D 53/228; B01D 71/021; B01D 71/024; B01D 71/38; B01D 2325/04; B01D 53/268; B01D 67/0006; B01D 69/02; B01D 2323/30; B01D 69/12

(57) ABSTRACT

Described herein are crosslinked graphene oxide and polycarboxylic acid based composite membranes that provide selective resistance for gases while providing water vapor permeability. Such composite membranes have a high water/air selectivity in permeability. The methods for making such membranes, and using the membranes for dehydrating or removing water vapor from gases are also described.

### CROSS REFERENCE TO RELATED APPLICATION

This application claims the benefit of U.S. Provisional Application 62/682,397, filed Jun. 8, 2018, which is incorporated by reference by its entirety.

### FIELD

The present embodiments are related to polymeric membranes, including membranes comprising graphene materials for applications such as removing water or water vapor from air or other gas streams and energy recovery ventilation (ERV).

### BACKGROUND

The presence of a high moisture level in the air may make people uncomfortable, and also may cause serious health issues by promoting growth of mold, fungus, as well as dust mites. In manufacturing and storage facilities, high humidity environments may accelerate product degradation, powder agglomeration, seed germination, corrosion, and other undesired effects, which is a concern for chemical, pharmaceutical, food and electronic industries. One of the conventional methods to dehydrate air include passing wet air through hydroscopic agents, such as glycol, silica gel, molecular sieves, calcium chloride, and phosphorus pentaoxide. This method has many disadvantages, for example, the drying agent has to be carried over in a dry air stream; and the drying agent also requires a replacement or regeneration over time, which makes the dehydration process costly and time consuming. Another conventional method of dehydration of air is cryogenic method by compressing and cooling the wet air to condense moisture followed by removing the condensed water, however, this method is highly energy consuming.

Compared with the conventional dehydration or dehumidification technologies described above, membrane-based gas dehumidification technology has distinct technical and economic advantages, such as low installation cost, easy operation, high energy efficiency and low process cost, as well as high processing capacity. This technology has been successfully applied in dehydration of nitrogen, oxygen, and compressed air. For ERV application, such as inside buildings, it is desirable to provide fresh air from outside, especially in hot and humid climates, where the outside air is much hotter and has more moisture than the air inside the building. Energy is required to cool and dehumidify the fresh air. The amount of energy required for heating or cooling and dehumidification can be reduced by transferring heat and moisture between the exhausting air and the incoming fresh air through an energy recovery ventilator (ERV) system. The ERV system comprising a membrane which separates the exhausting air and the incoming fresh air physically, but allows the heat and moisture exchange. The required key characteristics of the ERV membrane include: (1) low permeability of air and gases other than water vapors; and (2) high permeability of water vapor for effective transfer of moisture between the incoming and the outgoing air stream while blocking the passage of other gases; and (3) high thermal conductivity for effective heat transfer.

There is a need of membranes with high permeability of water vapor and low permeability of air for ERV application.

### SUMMARY

The disclosure relates to a graphene oxide (GO) membrane composition which may reduce water swelling and increase selectivity of H₂O/air permeability. Some membranes may provide an improved dehydration than traditional polymers, such as polyvinyl alcohols (PVA), poly(acrylic acid) (PAA), and polyether ether ketone (PEEK). The GO membrane composition may be prepared by using one or more water soluble cross-linkers. Methods of efficiently and economically making these GO membrane compositions are also described. Water can be used as a solvent in preparing these GO membrane compositions, which makes the membrane preparation process more environmentally friendly and more cost effective.

Some embodiments include a selectively permeable polymeric membrane such as a GO based dehydration membrane, comprising: a porous support; and a composite coated on the porous support comprising a crosslinked graphene oxide compound, wherein the crosslinked graphene oxide compound is formed by reacting a mixture comprising a graphene oxide compound with a crosslinker comprising a polycarboxylic acid; wherein the graphene oxide compound is suspended within the crosslinker and the weight ratio of graphene oxide to the crosslinker is at least 0.01.

Some embodiments include a method of making a dehydration membrane described herein, comprising: curing an aqueous mixture that is coated onto a porous support. In some embodiments, the curing is carried out at a temperature of 90° C. to 150° C. for about 30 seconds to about 3 hours to facilitate crosslinking within the aqueous mixture. The porous support is coated with the aqueous mixture by applying the aqueous mixture to the porous support, and repeating as necessary to achieve a layer of coating having a thickness of about 100 nm to about 4000 nm. The aqueous mixture is formed by mixing a graphene oxide compound, a crosslinker comprising a polycarboxylic acid, such as poly(acrylic acid), and an additive mixture, in an aqueous liquid.

Some embodiments include a method of removing water vapor from an unprocessed gas containing water vapor comprising passing the unprocessed gas through any of the dehydration membranes disclosed herein.

### BRIEF DESCRIPTION OF THE DRAWINGS

FIG. 1 is a depiction of a possible embodiment of a selective dehydration membrane.

FIG. 2 is a depiction of a possible embodiment for the method/process of making a separation/dehydration membrane element.

### DETAILED DESCRIPTION

### I. General

A selectively permeable membrane includes a membrane that is relatively permeable to one material and relatively impermeable for another material. For example, a membrane may be relatively permeable to water vapor and relatively impermeable to gases such as oxygen and/or nitrogen. The ratio of permeability for different materials may be useful in describing their selective permeability.

Unless otherwise indicated, when a compound or a chemical structure, such as graphene oxide, a crosslinker, or an additive, is referred to as being “optionally substituted,” it includes a compound or a chemical structure that either has no substituents (i.e., unsubstituted), or has one or more substituents (i.e., substituted). The term “substituent” has the broadest meaning known in the art, and includes a moiety that replaces one or more hydrogen atoms attached to a parent compound or structure. In some embodiments, a substituent may be any type of group that may be present on a structure of an organic compound, which may have a molecular weight (e.g., the sum of the atomic masses of the atoms of the substituent) of 15-50 g/mol, 15-100 g/mol, 15-150 g/mol, 15-200 g/mol, 15-300 g/mol, or 15-500 g/mol. In some embodiments, a substituent comprises, or consists of: 0-30, 0-20, 0-10, or 0-5 carbon atoms; and 0-30, 0-20, 0-10, or 0-5 heteroatoms, wherein each heteroatom may independently be: N, O, S, Si, F, Cl, Br, or I; provided that the substituent includes one C, N, O, S, Si, F, Cl, Br, or I atom. Examples of substituents include, but are not limited to, alkyl, alkenyl, alkynyl, heteroalkyl, heteroalkenyl, heteroalkynyl, aryl, heteroaryl, hydroxy, alkoxy, aryloxy, acyl, acyloxy, alkylcarboxylate, thiol, alkylthio, cyano, halo, thiocarbonyl, O-carbamyl, N-carbamyl, O-thiocarbamyl, N-thiocarbamyl, C-amido, N-amido, S-sulfonamido, N-sulfonamido, isocyanato, thiocyanato, isothiocyanato, nitro, silyl, sulfenyl, sulfinyl, sulfonyl, haloalkyl, haloalkoxyl, trihalomethanesulfonyl, trihalomethanesulfonamido, amino, etc.

For convenience, the term “molecular weight” is used with respect to a moiety or part of a molecule to indicate the sum of the atomic masses of the atoms in the moiety or part of a molecule, even though it may not be a complete molecule.

As used herein, the term “fluid communication” means that a fluid can pass through a first component and travel to and through a second component or more components regardless of whether they are in physical communication or the order of arrangement.

### II. Dehydration Membrane

The present disclosure relates to dehydration membranes where a highly selective hydrophilic GO-based composite material with high water vapor permeability, low gas permeability and high mechanical and chemical stability may be useful in applications where a dry gas or gas with low water vapor content is desired.

In some embodiments, the crosslinked GO-based membranes may comprise multiple layers, wherein at least one layer comprises a composite of a crosslinked graphene oxide (GO), or a GO-based composite. The crosslinked GO-based composite can be prepared by reacting a mixture comprising a graphene oxide compound and a crosslinker. It is believed that a crosslinked GO layer, with graphene oxide's hydrophilicity and selective permeability, may provide the membrane for broad applications where high moisture permeability with low gas permeability is important. In addition, these selectively permeable membranes may also be prepared using water as a solvent, which can make the manufacturing process much more environmentally friendly and cost effective.

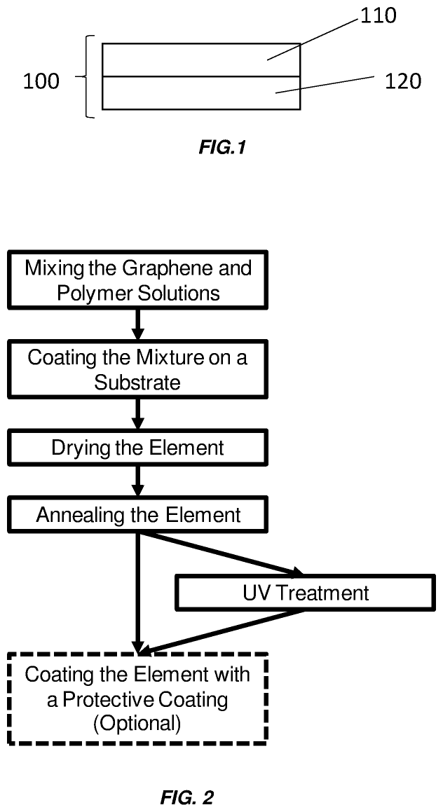

Generally, a dehydration membrane comprises a porous support and a composite coated onto the support. For example, as depicted in FIG. 1, selectively permeable membrane 100 can include porous support 120. Crosslinked GO-based composite 110 is coated onto porous support 120.

In some embodiments, the porous support comprises a polymer or hollow fibers. The porous support may be sandwiched between two composite layers. The crosslinked GO-based composite may further be in fluid communication with the support.

An additional optional layer, such as a protective layer, may also be present. In some embodiments, the protective layer can comprise a hydrophilic polymer. A protective layer may be placed in any position that helps to protect the selectively permeable membrane, such as a water permeable membrane, from harsh environments, such as compounds which may deteriorate the layers, radiation, such as ultraviolet radiation, extreme temperatures, etc.

In some embodiments, the gas passing through the membrane travels through all the components regardless of whether they are in physical communication or their order of arrangement.

A dehydration or water permeable membrane, such as one described herein, can be used to remove moisture from a gas stream. In some embodiments, a membrane may be disposed between a first gas component and a second gas component such that the components are in fluid communication through the membrane. In some embodiments, the first gas may contain a feed gas upstream and/or at the permeable membrane.

In some embodiments, the membrane can selectively allow water vapor to pass through while keeping other gases or a gas mixture, such as air, from passing through. In some embodiments, the membrane can be high moisture permeable. In some embodiments, the membrane can be low or not permeable to a gas or a gas mixture such as N₂ or air. In some embodiments, the membrane may be a dehydration membrane. In some embodiments, the membrane may be an air dehydration membrane. In some embodiments, the membrane may be a gas separation membrane. In some embodiments, a membrane that is moisture permeable and/or gas impermeable barrier membrane containing graphene material, e.g., graphene oxide, may provide desired selectivity between water vapor and other gases. In some embodiments, the selectively permeable membrane may comprise multiple layers, where at least one layer is a layer containing graphene oxide material.

In some embodiments, the moisture permeability may be measured by water vapor transfer rate. In some embodiments, the membrane exhibits a normalized water vapor flow rate of about 500-2000 g/m²/day; about 1000-2000 g/m²/day, about 1000-1500 g/m²/day, about 1500-2000 g/m²/day, about 1000-1700 g/m²/day; about 1200-1500 g/m²/day; about 1300-1500 g/m²/day, at least about 500 g/m²/day, about 500-1000 g/m²/day, about 500-750 g/m²/day, about 750-1000 g/m²/day, about 600-800 g/m²/day, about 800-1000 g/m²/day, about 1000 g/m²/day, about 1200 g/m²/day, about 1300 g/m²-day, or any normalized volumetric water vapor flow rate in a range bounded by any of these values. A suitable method for determining moisture (water vapor) transfer rates are ASTM E96.

### III. Porous Support

A porous support may be any suitable material and in any suitable form upon which a layer, such as a layers of the composite, may be deposited or disposed. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be polyamide (Nylon), polyimide (PI), polyvinylidene fluoride (PVDF), polyethylene (PE), polypropylene, polyethylene terephthalate (PET), polysulfone (PSF), polyether sulfone (PES), and/or mixtures thereof. In some embodiments, the polymer can comprise PET.

### IV. Crosslinked GO-Based Composite

The membranes described herein can comprise a crosslinked GO-based composite. Some membranes comprise a porous support and a crosslinked GO-based composite coated on the support. The crosslinked GO-based composite can be prepared by reacting a mixture comprising a graphene oxide compound and a crosslinker. The mixture that is reacted to form the crosslinked GO-based composite can comprise a graphene oxide compound and a crosslinker, such as a polycarboxylic acid. For example, the polycarboxylic acid can be poly(acrylic acid). In addition to the crosslinker, such as a polycarboxylic acid, an additional crosslinker such as polyvinyl alcohol or potassium borate may be present in the mixture. Additionally, an additive can be present in the mixture. A surfactant or a binder can also be present in the mixture. The mixture may form covalent bonds, such as crosslinking bonds, between the constituents of the composite (e.g., graphene oxide compound, the crosslinker(s), surfactant, binder, and/or additives). For example, a platelet of a graphene oxide compound may be bonded to another platelet; a graphene oxide compound may be bonded to a crosslinker (such as a polycarboxylic acid, a polyvinyl alcohol, or potassium borate); a graphene oxide compound may be bonded to an additive; a crosslinker (such as a polycarboxylic acid, a polyvinyl alcohol, or a potassium borate) may be bonded to an additive, and etc. In some embodiments, any combination of graphene oxide compound, a crosslinker (such as a polycarboxylic acid, a polyvinyl alcohol, or a lignin), a surfactant, a binder, and an additive can be covalently bonded to form a composite. In some embodiments, the surfactant, the binder, or the additive can be unreactive. In some embodiments, any combination of graphene oxide compound, a crosslinker (such as a polycarboxylic acid, a polyvinyl alcohol, or potassium borate), a surfactant, a binder, and an additive can be physically bonded to form a material matrix.

The crosslinked GO-based composite can have any suitable thickness. For example, some crosslinked GO-based layers may have a thicknesses of about 5-5000 nm, about 30-3000 nm, about 100-4000 nm, about 1000-4000 nm, about 100-3000 nm, about 900-3000 nm, about 500-3500 nm, about 900-3500 nm, about 1000-3500 nm, about 1500-3500 nm, about 2000-3000 nm, about 2500-3500 nm, about 2500-3000 nm, about 5-2000 nm, about 5-1000 nm, about 1000-1500 nm, about 1500-2000 nm, about 1000-2000 nm, about 10-500 nm, about 50-500 nm, about 20-1000 nm, about 10-100 nm, about 200-500 nm, about 800-1000 nm, about 700-900 nm, about 900-1100 nm, about 1100-1300 nm, about 1300-1500 nm, about 1500-1700 nm, about 1700-1900 nm, about 1900-2100 nm, about 2100-2300 nm, about 2300-2500 nm, about 2500-2700 nm, about 2700-2900 nm, about 2900-3100 nm, about 3100-3300 nm, about 3300-3500 nm, about 3500-3700 nm, about 3700-3900 nm, about 3900-4100 nm, about 100-500 nm, about 500-1000 nm, about 1000-1500 nm, about 1500-2000 nm, about 2000-2500 nm, about 2500-3000 nm, about 3000-3500 nm, about 3500-4000 nm, about 100 nm, about 200 nm, about 300 nm, about 500 nm, about 1000 nm, or any thickness in a range bounded by any of these values. Ranges or values above that encompass the following thicknesses are of particular interest: about 900 nm, about 1000 nm, about 1100 nm, about 1300 nm, about 1400 nm, about 1500 nm, about 1700 nm, about 1800 nm, about 2600 nm, and about 3000 nm.

A. Graphene Oxide

In general, graphene-based materials have many attractive properties, such as a 2-dimensional sheet-like structure with extraordinary high mechanical strength and nanometer scale thickness. The graphene oxide (GO), an exfoliated oxidation of graphite, can be mass produced at low cost. With its high degree of oxidation, graphene oxide has high water permeability and also exhibits versatility to be functionalized by many functional groups, such as amines or alcohols to form various membrane structures. Unlike traditional membranes, where the water is transported through the pores of the material, in graphene oxide membranes the transportation of water can be between the interlayer spaces. GO's capillary effect can result in long water slip lengths that offer a fast water transportation rate. Additionally, the membrane's selectivity and water flux can be controlled by adjusting the interlayer distance of graphene sheets, or by the utilization of different crosslinking moieties.

In the membranes disclosed, a GO material compound includes an optionally substituted graphene oxide. In some embodiments, the optionally substituted graphene oxide may contain a graphene which has been chemically modified, or functionalized. A modified graphene may be any graphene material that has been chemically modified, or functionalized. In some embodiments, the graphene oxide can be optionally substituted.

Functionalized graphene is a graphene oxide compound that includes one or more functional groups not present in graphene oxide, such as functional groups that are not OH, COOH, or an epoxide group directly attached to a C-atom of the graphene base. Examples of functional groups that may be present in functionalized graphene include halogen, alkene, alkyne, cyano, ester, amide, or amine.

In some embodiments, at least about 99%, at least about 95%, at least about 90%, at least about 80%, at least about 70%, at least about 60%, at least about 50%, at least about 40%, at least about 30%, at least about 20%, at least about 10%, or at least about 5% of the graphene molecules in a graphene oxide compound may be oxidized or functionalized. In some embodiments, the graphene oxide compound is graphene oxide, which may provide selective permeability for gases, fluids, and/or vapors. In some embodiments, the graphene oxide compound can also include reduced graphene oxide. In some embodiments, the graphene oxide compound can be graphene oxide, reduced-graphene oxide, functionalized graphene oxide, or functionalized and reduced-graphene oxide. In some embodiments, the graphene oxide compound is graphene oxide that is not functionalized.

It is believed that there may be a large number (^{˜}30%) of epoxy groups on GO, which may be readily reactive with hydroxyl groups at elevated temperatures. It is also believed that GO sheets have an extraordinary high aspect ratio which provides a large available gas/water diffusion surface as compared to other materials, and it has the ability to decrease the effective pore diameter of any substrate supporting material to minimize contaminant infusion while retaining flux rates. It is also believed that the epoxy or hydroxyl groups increases the hydrophilicity of the materials, and thus contributes to the increase in water vapor permeability and selectivity of the membrane.

In some embodiments, the optionally substituted graphene oxide may be in the form of sheets, planes or flakes. In some embodiments, the graphene material may have a surface area of about 100-5000 m²/g, about 150-4000 m²/g, about 200-1000 m²/g, about 500-1000 m²/g, about 1000-2500 m²/g, about 2000-3000 m²/g, about 100-500 m²/g, about 400-500 m²/g, or any surface area in a range bounded by any of these values.

In some embodiments, the graphene oxide may be platelets having 1, 2, or 3 dimensions with size of each dimension independently in the nanometer to micron range. In some embodiments, the graphene may have a platelet size in any one of the dimensions, or may have a square root of the area of the largest surface of the platelet, of about 0.05-100 μm, about 0.05-50 μm, about 0.1-50 μm, about 0.5-10 μm, about 1-5 μm, about 0.1-2 μm, about 1-3 μm, about 2-4 μm, about 3-5 μm, about 4-6 μm, about 5-7 μm, about 6-8 μm, about 7-10 μm, about 10-15 μm, about 15-20 μm, about 50-100 μm, about 60-80 μm, about 50-60 μm, about 25-50 μm, or any platelet size in a range bounded by any of these values.

In some embodiments, the GO material can comprise at least 70%, at least 75%, at least 80%, at least 85%, at least 90%, at least 95%, at least 97%, or at least 99% of graphene material having a molecular weight of about 5,000 Daltons to about 200,000 Daltons.

In some embodiments, the weight percentage of the graphene oxide relative to the total weight of the composite can be about 0.1-80 wt %, 0.1-50 wt %, about 0.1-10 wt %, about 5-10 wt %, about 1-5 wt %, about 0.1-1 wt %, about 0.5-1 wt %, about 0.6-0.8 wt %, about 0.8-0.9 wt %, about 0.7-0.75 wt %, about 0.8-0.85 wt %, about 1-50 wt %, about 10-50 wt %, about 1-10 wt %, about 10-50 wt %, about 40-50 wt %, about 50-70 wt %, about 60-80 wt %, 0.1-0.2 wt %, about 0.2-0.3 wt %, about 0.3-0.4 wt %, about 0.4-0.5 wt %, about 0.5-0.6 wt %, about 0.6-0.7 wt %, about 0.7-0.8 wt %, about 0.8-0.9 wt %, about 0.9-1 wt %, about 1-1.1 wt %, about 1.1-1.2 wt %, about 1.2-1.3 wt %, about 1.3-1.4 wt %, about 1.4-1.5 wt %, about 1.5-1.6 wt %, about 1.6-1.7 wt %, about 1.7-1.8 wt %, about 1.8-1.9 wt %, about 1.9-2 wt %, about 0.1-0.5 wt %, about 0.5-1 wt %, about 1-1.5 wt %, about 1.5-2 wt %, about 2-2.5 wt %, about 2.5-3 wt %, about 0.7 wt %, about 0.75 wt %, about 0.81 wt %, about 1.0 wt %, or any weight percentage in a range bounded by any of these values.

B. Crosslinker

The composite, such as a crosslinked GO-based composite, is formed by reacting a mixture containing a graphene oxide compound with a crosslinker, such as a polycarboxylic acid. The crosslinker comprising a polycarboxylic acid may further comprise at least one additional crosslinker such as a polyvinyl alcohol, or a borate salt.

The polycarboxylic acid can comprise polyacrylic acid, polymethacrylic acid, polymaleic+acid, or the like. In some embodiments, the polycarboxylic acid can comprise a poly(acrylic acid).

The average molecular weight of polycarboxylic acid may be about 10-4,000,000 Da, 50-3,000,000 Da, about 100-1,250,000 Da, about 250-1,000,000 Da, about 500-500,000 Da, about 1,000-450,000 Da, about 1,100-250,000 Da, about 1,200-240,000 Da, about 1,250-200,000 Da, about 2,000-150,000 Da, about 2,100-130,000 Da, about 3,000-100,000 Da, about 5,000-83,000 Da, about 5,100-70,000 Da, about 8,000-50,000 Da, about 8,600-38,000 Da, about 8,700-30,000 Da, about 10,000-16,000 Da, 500-1000 Da, 1000-1500 Da, 1500-2000 Da, 2000-2500 Da, 2500-3000 Da, 3000-3500 Da, 3500-4000 Da, 4000-4500 Da, 4500-5000 Da, 5000-5500 Da, 5500-6000 Da, 6000-6500 Da, 6500-7000 Da, 7000-7500 Da, 7500-8000 Da, 8000-8500 Da, 8500-9000 Da, 9000-9500 Da, 9500-10,000 Da, 50000-60000 Da, 60000-70000 Da, 70000-80000 Da, 80000-90000 Da, 90000-100000 Da, 100000-110000 Da, 110000-120000 Da, 120000-130000 Da, 130000-140000 Da, 140000-150000 Da, 150000-160000 Da, 160000-170000 Da, 170000-180000 Da, 180000-190000 Da, 190000-200000 Da, 200000-300000 Da, 400000-410000 Da, 410000-420000 Da, 420000-430000 Da, 430000-440000 Da, 440000-450000 Da, 450000-460000 Da, 460000-470000 Da, 470000-480000 Da, 480000-490000 Da, 490000-500000 Da, or any molecular weight in a range bounded by any of these values, such as 2,000 Da, 4,000 Da, 130,000 Da, or 450,000 Da. Examples of commercially available polyacrylic acids include AQUASET-529 (Rohm & Haas, Philadelphia, Pa., USA), CRITERION 2000 (Kemira, Helsinki, Finland, Europe), NF1 (H. B. Fuller, St. Paul, Minn., USA), and SOKALAN (BASF, Ludwigshafen, Germany, Europe). SOKALAN, is a water-soluble polyacrylic copolymer of acrylic acid and maleic acid, having a molecular weight of approximately 4,000 Da. AQUASET-529 is a composition containing polyacrylic acid cross-linked with glycerol and sodium hypophosphite as a catalyst. CRITERION 2000 is thought to be an acidic solution of a partial salt of polyacrylic acid, having a molecular weight of approximately 2,000 Da. NF1 is a copolymer of monomers containing carboxylic acid and hydroxyl functional groups, as well as monomers with neither functional groups; NF1 also contains chain transfer agents, such as sodium hypophosphite or organophosphate catalysts.

In some embodiments, the crosslinker comprising polycarboxylic acid, can further comprise an additional crosslinker of a polyvinyl alcohol. The polyvinyl alcohol may be present in any suitable amount. For example, with respect to the total weight of the composite, the polyvinyl alcohol may be present in an amount of about 0-90 wt %, about 0-50 wt %, about 10-50 wt %, about 20-50 wt %, about 30-40 wt %, about 30-50 wt %, about 50-90 wt %, about 70-80 wt %, or about 80-90 wt %, about 30 wt %, about 35 wt %, about 40 wt %, about 50 wt %, 25-30 wt %, 30-35 wt %, 35-40 wt %, 40-45 wt %, or 45-50 wt %. In some embodiments, the crosslinker does not contain polyvinyl alcohol.

The molecular weight of the polyvinyl alcohol (PVA) may be about 100-1,000,000 Daltons (Da), about 10,000-500,000 Da, about 10,000-50,000 Da, about 50,000-100,000 Da, about 70,000-120,000 Da, about 80,000-130,000 Da, about 90,000-140,000 Da, about 90,000-100,000 Da, about 95,000-100,000 Da, about 89,000-98,000 Da, 50000-55000 Da, 55000-60000 Da, 60000-65000 Da, 65000-70000 Da, 70000-75000 Da, 75000-80000 Da, 80000-85000 Da, 85000-90000 Da, 90000-95000 Da, 95000-100000 Da, 100000-105000 Da, 105000-110000 Da, 110000-115000 Da, 115000-120000 Da, about 89,000 Da, about 98,000 Da, or any molecular weight in a range bounded by any of these values.

In some embodiments, the crosslinker comprising polycarboxylic acid, can further comprise an additional crosslinker of a borate salt. The borate salt can comprise potassium borate. In some embodiments, the average molecular weight of the borate salt may be about 10-500 Da, about 50-250 Da, about 100-200 Da, about 150-175 Da, about 120 Da, about 130 Da, about 140 Da, about 150 Da, about 160 Da, about 170 Da, about 180 Da, or any molecular weight in a range bound by any of these values.

The weight percentage of borate salt based upon the total weight of the composite may be in a range of about 0-20 wt %, about 0-10 wt %, about 1-10 wt %, about 10-20 wt %, about 5-10 wt %, about 0-5 wt %, about 0-1 wt %, about 1-5 wt %, about 2-3 wt %, about 0.5-1 wt %, about 2.24 wt %, about 1-3 wt %, about 3-5 wt %, about 5-7 wt %, about 7-9 wt %, about 9-11 wt %, about 11-13 wt %, about 13-15 wt %, about 15-17 wt %, about 17-20 wt %, about 2 wt %, about 3 wt %, about 5 wt %, or about 0 wt %, or any weight percentage in a range bounded by any of these values.

C. Graphene Oxide is Suspended within the Crosslinker

In some embodiments, graphene oxide (GO) is suspended within the crosslinkers. The moieties of the GO and the crosslinker may be bonded. The bonding may be chemical or physical. The bonding can be direct or indirect; such as in physical communication through at least one other moiety. In some composites, the graphene oxide and the crosslinkers may be chemically bonded to form a network of cross-linkages or a composite material. The bonding also can be physical to form a material matrix, wherein the GO is physically suspended within the crosslinkers.

D. Weight Ratio of Graphene Oxide to the Crosslinker

In some embodiments, the weight ratio of the graphene oxide (GO) to the crosslinker including all crosslinkers, (weight ratio=weight of graphene oxide÷weight of all crosslinkers) can be at least 0.01, about 0.01-4, about 0.1-1, about 0.15-0.5, about 0.01-1, about 0.01-0.04, about 0.01-0.02, about 0.01-0.04, about 0.02-0.04, about 0.03-0.04, about 0.01-0.1, about 0.01-0.5, about 0.1-0.5, about 0.5-1, about 0.02, about 0.033, about 0.01 (for example, when the weight ratio of graphene oxide/polyacrylic acid/polyvinyl alcohol is 1/50/50 in EX-5, in the Example Section), or any weight ratio in a range bounded by any of these values. In some embodiments, the weight ratio of the graphene oxide to the crosslinker can be in a range of 0.01-0.04.

In some embodiments, the weight ratio of the crosslinker including all crosslinkers to the GO (weight ratio=weight of all crosslinkers÷weight of graphene oxide) can be about 0.25-100, about 0.5-100, about 1-100, about 10-100, about 10-50, about 20-40, about 40-60, about 50-100, about 1-10, about 30, about 50, or about 100 (for example, the weight ratio of GO/PAA/PVA is 1/50/50, EX-5 in the Example Section, so [50+50]/1=100), or any weight ratio in a range bounded by any of these values. In some membranes, the weight ratio of the crosslinker to the graphene oxide can be in a range of 10-100.

In some composites, the weight ratio of additional crosslinkers to polycarboxylic acid (weight ratio=weight of additional crosslinkers÷weight of polycarboxylic acid) can be about 0.0-2, about 0-1, about 0.20-0.75, about 0.25-0.60, about 0.2-0.3, about 0.4-0.6, about 0.5-0.6, about 0, or about 1 (for example, the weight ratio of polyacrylic acid/polyvinyl alcohol is 50/50 in EX-5 in the Example Section), or any weight ratio in a range bounded by any of these values. In some embodiments, the weight ratio of additional crosslinkers to polycarboxylic acid is about 1. In some embodiments, no additional crosslinker is present in addition to a polycarboxylic acid.

In some embodiments, the weight percentage of polycarboxylic acid relative to the total composition can be about 20-90 wt %, about 20-30 wt %, about 20-40 wt %, about 30-40 wt %, about 30-35 wt %, about 40-90 wt %, about 40-70 wt %, about 40-50 wt %, about 50-60 wt %, about 60-70 wt %, about 70-80 wt %, about 70-75 wt %, about 80-90 wt %, about 29.7%, about 34.9%, about 35.0%, about 40.7%, about 69.9%, about 74.6%, about 75.2%, or any weight percentage in a range bounded by any of these values.

It is believed that crosslinking the graphene oxide can enhance the GO's mechanical strength and water or water vapor permeable properties by creating strong chemical bonding between the moieties within the composite and wide channels between graphene platelets to allow water or water vapor to pass through the platelets easily. In some embodiments, at least about 1%, at least about 5%, at least about 10%, at least about 20%, at least about 30%, at least about 40% about 50%, at least about 60%, at least about 70%, at least about 80%, at least about 90%, at least about 95%, or all of the graphene oxide platelets may be crosslinked. In some embodiments, the majority of the graphene material may be crosslinked. The amount of crosslinking may be estimated based on the weight of the cross-linker as compared to the total amount of graphene material.

### E. Additives

An additive or an additive mixture may, in some instances, improve the performance of the composite. Some crosslinked GO-based composites can also comprise an additive mixture. In some embodiments, the additive mixture can comprise calcium chloride, lithium chloride, sodium lauryl sulfate, a lignin, or any combination thereof. In some embodiments, any of the moieties in the additive mixture may also be bonded with the material matrix. The bonding can be physical or chemical (e.g., covalent). The bonding can be direct or indirect.

Some additive mixtures can comprise calcium chloride. In some embodiments, calcium chloride is about 0-45 wt %, 0-35 wt %, about 0-30 wt %, about 10-30 wt %, about 20-30 wt %, about 10-20 wt %, about 20-25 wt %, about 15-20 wt %, about 25-30 wt %, about 0-10 wt %, about 15 wt %, about 16 wt %, about 23 wt %, about 25 wt %, about 28 wt %, about 9-11 wt %, about 11-13 wt %, about 13-15 wt %, about 15-17 wt %, about 17-19 wt %, about 19-21 wt %, about 21-23 wt %, about 23-25 wt %, about 25-27 wt %, about 27-29 wt %, about 29-31 wt %, about 31-33 wt %, about 33-35 wt %, about 35-37 wt %, about 37-39 wt %, about 39-41 wt %, about 41-43 wt %, about 43-45 wt %, of the total weight of the composite, or any weight percentage in a range bounded by any of these values. Any of the above ranges which encompass any of the following percentages of the calcium chloride are of particular interest: 16.2 wt %, 22.6 wt %, 27.9 wt %, and 28.0 wt %.

Some additive mixture can comprise lithium chloride. In some embodiments, lithium chloride is about 0-80 wt %, 0-70 wt %, about 0-30 wt %, about 0-10 wt %, about 10-30 wt %, about 30-70 wt %, about 60-80 wt %, 0-50 wt %, 20-25 wt %, about 10-20 wt %, about 20-30 wt %, about 50-70 wt %, 59-61 wt %, 61-63 wt %, 63-65 wt %, 65-67 wt %, 67-69 wt %, 69-71 wt %, 71-73 wt %, 73-75 wt %, 75-77 wt %, 77-79 wt %, 79-81 wt %, about 60-70, about 70-80, about 60-65, about 65-70, about 70-75, about 75-80, about 69 wt %, or about 0 wt %, or any weight percentage in a range bounded by any of these values.

In some embodiments, the additive mixture can comprise a borate salt. In some embodiments, the borate salt comprises K₂B₄O₇, Li₂B₄O₇, or Na₂B₄O₇. In some embodiments, the borate salt can comprise K₂B₄O₇. In some embodiments, the weight percentage of borate salt based upon the total weight of the composite may be in a range of about 0-20 wt %, about 0-10 wt %, about 1-10 wt %, about 10-20 wt %, about 5-10 wt %, about 0-5 wt %, about 0-1 wt %, about 1-5 wt %, about 2-3 wt %, about 0.5-1 wt %, about 2.24 wt %, about 2 wt %, about 3 wt %, about 5 wt %, or about 0 wt %, or any weight percentage in a range bounded by any of these values.

The additive or the additive mixture can comprise silica nanoparticles. In some embodiments, at least one other additive is present with the silica nanoparticles. In some embodiments, the silica nanoparticles may have an average size of about 5-200 nm, about 6-100 nm, about 6-50 nm, about 7-50 nm, about 7-20 nm, about 5-9 nm, about 5-15 nm, about 10-20 nm, about 15-25 nm, about 18-22 nm, 1-3 nm, about 3-5 nm, about 5-7 nm, about 7-9 nm, about 9-11 nm, about 11-13 nm, about 13-15 nm, about 15-17 nm, about 17-19 nm, about 19-21 nm, about 21-23 nm, about 23-25 nm, about 25-27 nm, about 27-29 nm, about 29-31 nm, about 31-33 nm, about 7 nm, or about 20 nm, or any size in a range bounded by any of these values. The average size for a set of nanoparticles can be determined by taking the average volume and then determining the diameter associated with a comparable sphere which displaces the same volume to obtain the average size.

In some embodiments, the silica nanoparticles are about 0-15 wt %, about 0-10 wt %, about 0-5 wt %, about 1-10 wt %, about 0.1-3 wt %, about 2-4 wt %, about 3-5 wt %, about 4-6 wt %, about 3-4 wt %, about 6-7 wt %, about 3-7 wt %, about 0-7 wt %, about 1-3 wt %, about 3-5 wt %, about 5-7 wt %, about 7-9 wt %, about 9-11 wt %, about 11-13 wt %, about 13-15 wt %, about 15-17 wt %, about 17-19 wt %, about 19-21 wt %, about 0 wt %, about 3.1 wt %, about 3.3 wt %, about 3.7 wt %, about 6.3 wt %, about 6.7 wt %, about 6.9 wt %, and about 10 wt % of the total weight of the composite, or any weight percentage in a range bounded by any of these values. In some embodiments, there is no silica nanoparticles present in the composite.

### V. Protective Coating

Some membranes may further comprise a protective coating. For example, the protective coating can be disposed on top of the membrane to protect it from the environment. The protective coating may have any composition suitable for protecting a membrane from the environment, Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH) and poly (sodium 4-styrene sulfonate) (PSS), and any combinations thereof. In some embodiments, the protective coating can comprise PVA.

### VI. Methods of Making Dehydration Membranes

Some embodiments include methods for making a dehydration membrane comprising: (a) mixing the graphene oxide material, the crosslinker comprising a polycarboxylic acid, and the additive in an aqueous mixture to generate a composite coating mixture; (b) applying the coating mixture on a porous support to form a coated support; (c) repeating step (b) as necessary to achieve the desired thickness of coating; and (d) curing the coating at a temperature of about 90-150° C. for about 30 seconds to about 3 hours to facilitate crosslinking within the coated mixture. In some embodiments, the method optionally comprises pre-treating the porous support. In some embodiments, the method optionally further comprises coating the assembly with a protective layer. An example of a possible method embodiment of making an aforementioned membrane is shown in FIG. 2.

In some embodiments, the crosslinker comprising the polycarboxylic acid, in step (a), can also comprise one or more additional crosslinkers, such as a polyvinyl alcohol and/or a borate salt. In some embodiments, the additive in step (a) can comprise additional additives, such as CaCl₂, LiCl, sodium polystyrene sulfonate, a surfactant such as sodium lauryl sulfate, or a binder such as a lignin, or any combinations thereof. The lignin in step (a) can comprise a sulfonated lignin, such as a lignosulfonate or a lignano sulfonate salt, such as sodium lignosulfonate, calcium lignosulfonate, magnesium lignosulfonate, potassium lignosulfonate, etc. In some embodiment, the ligin is sodium lignosulfonate.

In some embodiments, the step of mixing an aqueous mixture of the graphene oxide material, the crosslinker comprising polycarboxylic acid, and the additive mixture can be accomplished by dissolving appropriate amounts of the graphene oxide compound, the crosslinker, and the additives (e.g. borate salt, calcium chloride) in water. Some methods comprise mixing at least two separate aqueous mixtures, e.g., a graphene oxide based mixture and a crosslinker and additive based mixture, then mixing appropriate mass ratios of the mixtures together to achieve the desired results. Other methods comprise creating one aqueous mixture by dissolving appropriate amounts of the graphene oxide material, the crosslinker, and the additives dispersed within the mixture. In some embodiments, the mixture can be agitated at temperatures and times sufficient to ensure uniform dissolution of the solute. The result is a mixture that can be coated onto the support and reacted, such as crosslinked, to form the composite coating mixture.

In some embodiments, the porous support can be optionally pre-treated to aid in the adhesion of the composite layer to the porous support. In some embodiments, the porous support can be modified to become more hydrophilic. For example, the modification can comprise a corona treatment using 70 W power with 2 counts at a speed of 0.5 m/min.

In some embodiments, applying the mixture to the porous support can be done by methods known in the art for creating a layer of desired thickness. In some embodiments, applying the coating mixture to the substrate can be achieved by vacuum immersing the substrate into the coating mixture first, and then drawing the solution onto the substrate by applying a negative pressure gradient across the substrate until the desired coating thickness can be achieved. In some embodiments, applying the coating mixture to the substrate can be achieved by blade coating, spray coating, dip coating, die coating, or spin coating. In some embodiments, the method can further comprise gently rinsing the substrate with deionized water after each application of the coating mixture to remove excess loose material. In some embodiments, the coating is done such that a composite layer of a desired thickness is created. The desired thickness of the composite layer can be in a range of about 5-4000 nm, about 5-3000 nm, about 100-3000 nm, 5-2000 nm, about 5-1000 nm, about 1000-2000 nm, about 10-500 nm, about 500-1000 nm, about 800-1000 nm, about 1000-1200 nm, about 1200-1400 nm, about 1300-1500 nm, about 1500-2000 nm, about 1700-1800 nm, about 2000-3000 nm, about 2500-3000 nm, about 2500-2600 nm, about 100-1500 nm, about 50-500 nm, about 500-1500 nm, 100-200 nm, about 200-300 nm, about 300-500 nm, about 400-600 nm, about 10-100 nm, about 100 nm, about 200 nm, about 250 nm, or about 300 nm, about 500 nm, about 1000 nm, about 1500 nm, about 2500 nm, or any thickness in a range bounded by any of these values. Ranges that encompass the following thicknesses are of particular interest: about 900 nm, about 1100 nm, about 1300 nm, about 1400 nm, about 1700 nm, about 1800 nm, about 2600 nm, or about 3000 nm. In some embodiments, the number of layers can range from 1-250, from about 1-100, from 1-50, from 1-20, from 1-15, from 1-10, or 1-5. This process results in a fully coated substrate, or a coated support.

For some methods, curing the coated support can then be done at temperatures and times sufficient to facilitate crosslinking between the moieties of the aqueous mixture deposited on the porous support. In some embodiments, the coated support can be heated at a temperature of about 45-200° C., about 90-170° C., about 90-150° C., about 100° C., about 110° C., or about 140° C. In some embodiments, the coated support can be heated for a duration of at least about 30 seconds, at least about 1 minute, at least about 5 minutes, at least about 6 minutes, at least about 15 minutes, at least about 30 minutes, at least 45 minutes, up to about 1 hour, up to about 1.5 hours, up to about 3 hours; with the time required generally decreasing for increasing temperatures. In some embodiments, the substrate can be heated at about 110° C. for about 30 minutes. In some embodiments, the substrate can be heated at about 100° C. for about 3 minutes. This process results in a cured membrane.

In some embodiments, the method for fabricating a membrane can further comprise subsequently applying a protective coating on the membrane. In some embodiments, the applying a protective coating comprises adding a hydrophilic polymer layer. In some embodiments, applying a protective coating comprises coating the membrane with a polyvinyl alcohol aqueous solution. Applying a protective layer can be achieved by methods such as blade coating, spray coating, dip coating, spin coating, and etc. In some embodiments, applying a protective layer can be achieved by dip coating of the membrane in a protective coating solution for about 1-10 minutes, about 1-5 minutes, about 5 minutes, or about 2 minutes. In some embodiments, the method further comprises drying the membrane at a temperature of about 75-120° C. for about 5-15 minutes, or at about 90° C. for about 10 minutes. This process results in a membrane with a protective coating.

### VII. Methods for Reducing Water Vapor Content of a Gas Mixture

A selectively permeable membrane, such as dehydration membrane, described herein may be used in methods for removing water vapor or reducing water vapor content from an unprocessed gas mixture, such as air, containing water vapor, for applications where dry gases or gases with low water vapor content are desired. The method comprises passing a first gas mixture (an unprocessed gas mixture), such as air, containing water vapor through the membrane, whereby the water vapor is allowed to pass through and removed, while other gases in the gas mixture, such as air, are retained to generate a second gas mixture (a dehydrated gas mixture) with reduced water vapor content.

A dehydrating membrane may be incorporated into a device that provides a pressure gradient across the dehydrating membrane so that the gas to be dehydrated (the first gas) has a higher pressure than that of the water vapor on the opposite side of the dehydrating membrane where the water vapor is received, then removed, resulting in a dehydrated gas (the second gas).

The permeated gas mixture, such as air or a secondary dry sweep stream may be used to optimize the dehydration process. If the membrane were totally efficient in water vapor separation, all the water vapor in the feed stream would be removed, and there would be nothing left to sweep it out of the system. As the process proceeds, the partial pressure of the water vapor on the feed or bore side becomes lower, and the pressure on the shell-side becomes higher. This pressure difference tends to prevent additional water vapor from being expelled from the module. Since the object is to make the bore side dry, the pressure difference interferes with the desired operation of the device. A sweep stream may therefore be used to remove the water vapor from the feed or bore side, in part by absorbing some of the water vapor, and in part by physically pushing the water vapor out.

If a sweep stream is used, it may come from an external dry source or a partial recycle of the product stream of the module. In general, the degree of dehumidification will depend on the pressure ratio of product flow to feed flow (for water vapor across themembrane) and on the product recovery. Good membranes have a high product recovery with low level of product humidity, and/or high volumetric product flow rates.

In some embodiments, the membrane is permeable to water vapor, having a water vapor permeability of at least 5×10⁻⁶ (g/m²·s·Pa), about 1×10⁻⁵ (g/m²·s·Pa) to about 5×10⁻⁵ (g/m²·s·Pa), about 1×10⁻⁵ (g/m²·s·Pa), about 1.5×10⁻⁵ (g/m²·s·Pa), about 2×10⁻⁵ (g/m²·s·Pa), about 2.5×10⁻⁵ (g/m²·s·Pa), about 3×10⁻⁵ (g/m²·s·Pa), about 3.5×10⁻⁵ (g/m²·s·Pa), about 4×10⁻⁵ (g/m²·s·Pa), about 4.5×10⁻⁵ (g/m²·s·Pa), about 4.6×10⁻⁵ (g/m²·s·Pa), or about 5×10⁻⁵ (g/m²·s·Pa). In some embodiments, the membrane is impermeable or relatively impermeable to the other gases other than water vapor, such as N₂ gas, having a gas permeability of less than 1×10⁻⁶ (L/m²·s·Pa), less than 2.5×10⁻⁶ (L/m²·s·Pa), less than 5×10⁻⁶ (L/m²·s·Pa), less than 1×10⁻⁵ (L/m²·s·Pa), about 1×10⁻⁵ (L/m²·s·Pa), about 1×10⁻⁶ (L/m²·s·Pa), about 1×10⁻⁷ (L/m²·s·Pa), about 1×10⁻⁸ (L/m²·s·Pa), or about 8×10⁻⁸ (L/m²·s·Pa). In some embodiments, the gas, other than water vapor, can comprise air, nitrogen, hydrogen, carbon dioxide, and/or a short chain hydrocarbon. In some embodiments the short chain hydrocarbon can be methane, ethane, or propane.

The membranes described herein can be easily made at low cost, and may outperform existing commercial membranes in either volumetric product flow or product recovery.

### Embodiments

The following embodiments are specifically contemplated.

Embodiment 1. A dehydration membrane comprising:

a porous support; and

a composite coated on the support comprising a crosslinked graphene oxide compound,

wherein the crosslinked graphene oxide compound is formed by reacting a mixture comprising a graphene oxide compound and a crosslinker comprising a polycarboxylic acid;

wherein the graphene oxide compound is suspended within the crosslinker and the weight ratio of graphene oxide to the crosslinker is at least 0.01.

Embodiment 2. The dehydration membrane of embodiment 1, wherein the support is a non-woven fabric comprising polypropylene, polyamide, polyimide, polyvinylidene fluoride, polyethylene, polyethylene terephthalate, polysulfone, polyether sulfone, or a combination thereof.
Embodiment 3. The dehydration membrane of embodiment 1 or 2, wherein the graphene oxide compound comprises a graphene oxide, reduced-graphene oxide, functionalized graphene oxide, functionalized and reduced-graphene oxide, or a combination thereof.
Embodiment 4. The dehydration membrane of embodiment 3, wherein the graphene oxide compound comprises graphene oxide.
Embodiment 5. The dehydration membrane of embodiment 1, 2, 3, or 4, wherein the polycarboxylic acid comprises poly(acrylic acid).
Embodiment 6. The dehydration membrane of embodiment 1, 2, 3, 4, or 5, wherein the composite or mixture further comprises an additional crosslinker comprising polyvinyl alcohol, a borate salt, or a combination thereof.
Embodiment 7. The dehydration membrane of embodiment 6, wherein the polyvinyl alcohol is about 0 wt % to about 50 wt % of the composite.
Embodiment 8. The dehydration membrane of embodiment 6 or 7, wherein the borate salt is about 0 wt % to about 20 wt % of the composite.
Embodiment 9. The dehydration membrane of embodiment 6, 7, or 8, wherein the borate salt comprises potassium borate.
Embodiment 10. The dehydration membrane of embodiment 1, 2, 3, 4, 5, 6, 7, 8, or 9, wherein the composite or mixture further comprises a surfactant.
Embodiment 11. The dehydration membrane of embodiment 10, wherein the surfactant is sodium lauryl sulfate.
Embodiment 12. The dehydration membrane of embodiment 1, 2, 3, 4, 5, 6, 7, 8, 9, 10, or 11, the composite or mixture further comprises a binder.
Embodiment 13. The dehydration membrane of embodiment 12, wherein the binder comprises a lignin.
Embodiment 14. The dehydration membrane of embodiment 13, wherein the lignin comprises sodium lignosulfonate, calcium lignosulfonate, magnesium lignosulfonate, potassium lignosulfonate, or a combination thereof.
Embodiment 15. The dehydration membrane of embodiment 6, wherein the weight ratio of the additional crosslinker to the polycarboxylic acid is about 0 to about 1.
Embodiment 16. The dehydration membrane of embodiment 1, 2, 3, 4, 5, 6, 7, 8, 9, 10, 11, 12, 13, 14, or 15, wherein the weight ratio of the crosslinker to the graphene oxide is about 0.5 to about 100.
Embodiment 17. The dehydration membrane of embodiment 1, 2, 3, 4, 5, 6, 7, 8, 9, 10, 11, 12, 13, 14, 15, or 16, wherein the composite or mixture further comprises an additive mixture comprising CaCl₂, LiCl, sodium polystyrene sulfonate, or a combination thereof.
Embodiment 18. The dehydration membrane of embodiment 17, wherein the CaCl₂) is about 0 wt % to about 35 wt % of the composite.
Embodiment 19. The dehydration membrane of embodiment 17, wherein the LiCl is about 0 wt % to about 10 wt % of the composite.
Embodiment 20. The dehydration membrane of embodiment 1, 2, 3, 4, 5, 6, 7, 8, 9, 10, 11, 12, 13, 14, 15, 16, 17, 18, or 19, wherein the composite is in a layer having a thickness of about 100 nm to about 4000 nm.
Embodiment 21. The dehydration membrane of embodiment 1, 2, 3, 4, 5, 6, 7, 8, 9, 10, 11, 12, 13, 14, 15, 16, 17, 18, 19, or 20, having higher permeability for water vapor than a gas.
Embodiment 22. The dehydration membrane of embodiment 1, 2, 3, 4, 5, 6, 7, 8, 9, 10, 11, 12, 13, 14, 15, 16, 17, 18, 19, or 20, having water vapor permeability at least 2-fold higher than the permeability for a gas.
Embodiment 23. The dehydration membrane of embodiment 1, 2, 3, 4, 5, 6, 7, 8, 9, 10, 11, 12, 13, 14, 15, 16, 17, 18, 19, or 20, having water vapor permeability at least 3-fold higher than the permeability for a gas.
Embodiment 24. A method for dehydrating a gas comprising:

applying a first gas component comprising water vapor to the dehydration membrane of embodiments 1, 2, 3, 4, 5, 6, 7, 8, 9, 10, 11, 12, 13, 14, 15, 16, 17, 18, 19, 20, 21, 22, or 23; and

allowing the water vapor to pass through the dehydration membrane and to be removed; and generating a second gas component that has lower water vapor content than the first gas component.

Embodiment 25. A method of making a dehydration membrane comprising:

curing an aqueous mixture that is coated onto a porous support;

wherein the aqueous mixture that is coated onto the porous support is cured at a temperature of 90° C. to 150° C. for about 30 seconds to about 3 hours to facilitate crosslinking within the aqueous mixture;

wherein the porous support is coated with the aqueous mixture by applying the aqueous mixture to the porous support, and repeating as necessary to achieve a layer of coating having a thickness of about 100 nm to about 4000 nm; and

wherein the aqueous mixture is formed by mixing a graphene oxide compound, a crosslinker comprising a polycarboxylic acid, and an additive mixture, in an aqueous liquid.

Embodiment 26. The method of embodiment 25, wherein the crosslinker comprising polycarboxylic acid further comprises an additional crosslinker comprising a polyvinyl alcohol, potassium borate, or a combination thereof.
Embodiment 27. The method of embodiment 25 or 26, wherein the additive mixture comprises CaCl₂, LiCl, or a combination thereof.

### EXAMPLES

It has been discovered that embodiments of the selectively permeable membranes described herein have improved performance as compared to other selectively permeable membranes. These benefits are further demonstrated by the following examples, which are intended to be illustrative of the disclosure only, but are not intended to limit the scope or underlying principles in any way.

### Example 1.1.1: Preparation of a Coating Mixture

Preparation of GO Solution 1: GO was prepared from graphite using the modified Hummers method. Graphite flakes (2.0 g) (Sigma Aldrich, St. Louis, Mo., USA, 100 mesh) were oxidized in a mixture of 2.0 g of NaNO₃ (Aldrich), 10 g KMnO₄ of (Aldrich) and 96 mL of concentrated H₂SO₄ (Aldrich, 98%) at 50° C. for 15 hours. The resulting paste like mixture was poured into 400 g of ice followed by adding 30 mL of hydrogen peroxide (Aldrich, 30%). The resulting solution was then stirred at room temperature for 2 hours to reduce the manganese dioxide, then filtered through a filter paper and washed with DI water. The solid was collected and then dispersed in DI water with stirring, centrifuged at 6300 rpm for 40 minutes, and the aqueous layer was decanted. The remaining solid was then dispersed in DI water again and the washing process was repeated 4 times. The purified GO was then dispersed in 10 mL of DI water under sonication (power of 10 W) for 2.5 hours to get the GO dispersion (0.4 wt %) as GO-1.

The above 0.4 wt % GO dispersion (GO-1) can be further diluted with DI water to give the GO dispersion with 0.1 wt % as GO-2.

Preparation of a Coating Mixture: A 10 mL of 2.5 wt % poly(acrylic acid) solution was prepared by dissolving poly(acrylic acid) (PAA) (2.5 g, Avg. Mv. ^{˜}450,000, Aldrich) in DI water. Next, 0.1 mL of a 0.1 wt % aqueous solution of CaCl₂) (anhydrous, Aldrich) was added. Then, 0.21 mL of a 0.47 wt % of K₂B₄O₇ (Aldrich) was added and the resulting solution was stirred until well mixed to generate a crosslinker solution (XL-1). Then, GO-1 (10 mL) and XL-1 (8 mL) solutions were combined with 10 mL of DI water and sonicated for 6 minutes to ensure uniform mixing to create a coating mixture (CS-1).

Preparation of a Coating Solution: First, 1 mL of GO-2 (0.1 wt %) was added into 6.1 mL of water and sonicated for about 3 minutes. After GO-2 was completely dispersed in water, 1 mL of PAA (2.5% aqueous solution) was added, and the resulting mixture was sonicated for about 8 minutes. After PAA was completely dissolved in the solution, 0.6 mL of LiCl (5%) (Sigma Aldrich, St. Louis, Mo., USA) was added and the resulting mixture was sonicated for about 6 minutes to completely dissolve LiCl in the solution to generate a coating solution CS-2.

Other coating mixtures or coating solutions were made in a manner similar to CS-1 or CS-2, except that different polymers or additives were utilized in addition to poly(acrylic acid) (PAA), such as poly(vinyl alcohol) (PVA), sodium lignosulfonate (LSU), sodium lauryl sulfate (SLS), etc., and with different weight ratios as shown in Table 1.

### Example 2.1.1: Preparation of a Membrane

Substrate treatment: A porous polypropylene substrate (Celgard 2500) was first performed hydrophilic modification with corona treatment using power of 70 W, 3 counts, speed of 0.5 m/min.

Coating and curing: A coating solution prepared was applied onto a freshly treated substrate described above with 200 m wet gap. The resulting coated substrate was dried, then cured at 110° C. for 5 minutes to generate a membrane, such as any of EX-1, EX-2, EX-3, EX-4, EX-5, EX-6, EX-7, and EX-8 shown in Table 1.

### Example 3.1.1: Measurement of Selectively Permeable Membranes

Membranes of EX-1, EX-2, EX-3, EX-4, EX-5, EX-6, EX-7, and EX-8 were tested for water vapor transmission rate (WVTR) as described in ASTM E96 standard method, at a temperature of 20° C. and 100% relative humidity (RH), and/or for water vapor permeance as described in ASTM E96 standard method, at a temperature of 20° C. and 100% relative humidity (RH), and/or for N₂ permeance. The results are shown in Table 1.

TABLE 1
Water vapor transfer rate (WVTR) and permeance for water vapor and nitrogen gas for selectively permeable membranes

| | | | | | Water vapor | | |
|---|---|---|---|---|---|---|---|
| | | | | | Permeance | WVTR | N₂ Permeance |
| EX | Composition | Weight Ratio | Thickness | Substrate | (g/m² · s · Pa) | (g/m²/Day) | (L/m² · s · Pa) |
| 1 | GO/PAA/CaCl₂/SLS | 1/100/30/2 | 1.7 um | polypropylene | | 1433 | 1 × 10⁻⁶ |
| 2 | GO/PAA/CaCl₂/SLS | 1/100/40/2 | 1.8 um | polypropylene | | 1339 | |
| 3 | GO/PAA/CaCl₂/SLS | 1/100/30/2 | 1.3 um | polypropylene | | 1340 | |
| 4 | GO/PAA/CaCl₂/SLS | 1/100/40/2 | 1.4 um | polypropylene | | 1409 | |
| 5 | GO/PAA/PVA/CaCl₂/SLS | 1/50/50/40/2 | 0.9 um | polypropylene | | 1497 | 1 × 10⁻⁷ |
| 6 | GO/PAA/LiCl | 1/30/70 | 3.0 um | polypropylene | 3.5 × 10⁻⁵ | | 1 × 10⁻⁸ |
| 7 | GO/PAA/LSU/LiCl/KBO | 1/100/15/15/3 | 3.0 um | polypropylene | 4.6 × 10⁻⁵ | | |
| 8 | GO/PAA/PVA/CaCl₂/SLS/KBO | 1/50/50/40/2.4/5 | 2.6 um | polypropylene | | 1710 | 1 × 10⁻⁵ |
| 9 | GO/PAA/PSS/SLS/CaCl₂ | 1/50/50/2/20 | 1.1 um | polypropylene | | 1610 | 8 × 10⁻⁸ |

NOTE:
GO = Graphene Oxide; PAA = Poly(acrylic acid); PVA = Poly(vinyl alcohol); CaCl₂ = Calcium Chloride; SLS = Sodium Lauryl Sulfate; LiCl = Lithium Chloride; LSU = Sodium Lignosulfonate; KBO = Potassium Borate. PSS = sodium polystyrene sulfonate.

As water has density of 1 kg/L or 1000 g/L, for the GO-crosslinked membrane EX-6, the water vapor permeance is equivalent to 3.5×10⁻⁸ L/m²·s·Pa. Considering its N₂ permeance is 1×10⁻⁸ L/m²·s·Pa, the ratio of the water vapor permeance to the N₂ gas permeance for EX-6 is about 3.5. Thus, water vapor is significantly more permeable than N₂ gas to the GO-crosslinked membrane EX-6.

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the inventors for carrying out the embodiments. Of course, variations on these described embodiments will become apparent to those of ordinary skill in the art upon reading the foregoing description. The inventor expects skilled artisans to employ such variations as appropriate, and the inventors intend for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A dehydration membrane comprising:
a porous support; and
a composite coated on the porous support comprising a crosslinked graphene oxide compound,
wherein the crosslinked graphene oxide compound is formed by reacting a mixture comprising a graphene oxide compound and a crosslinker comprising a polycarboxylic acid;
wherein the graphene oxide compound is suspended within the crosslinker and the weight ratio of the graphene oxide compound to the crosslinker is at least 0.01.

2. The dehydration membrane of claim 1, wherein the porous support is a non-woven fabric comprising polypropylene, polyamide, polyimide, polyvinylidene fluoride, polyethylene, polyethylene terephthalate, polysulfone, polyether sulfone, or a combination thereof.

3. The dehydration membrane of claim 1, wherein the graphene oxide compound comprises a graphene oxide, reduced-graphene oxide, functionalized graphene oxide, functionalized and reduced-graphene oxide, or a combination thereof.

4. The dehydration membrane of claim 3, wherein the graphene oxide compound comprises graphene oxide.

5. The dehydration membrane of claim 1, wherein the polycarboxylic acid comprises poly(acrylic acid).

6. The dehydration membrane of claim 1, wherein the composite or mixture further comprises an additional crosslinker of polyvinyl alcohol, a borate salt, or a combination thereof.

7. The dehydration membrane of claim 6, wherein the polyvinyl alcohol is about 0 wt % to about 50 wt % of the composite.

8. The dehydration membrane of claim 6, wherein the borate salt is about 0 wt % to about 20 wt % of the composite.

9. The dehydration membrane of claim 6, wherein the borate salt comprises potassium borate.

10. The dehydration membrane of claim 1, wherein the composite or mixture further comprises a surfactant.

11. The dehydration membrane of claim 10, wherein the surfactant is sodium lauryl sulfate.

12. The dehydration membrane of claim 1, wherein the composite or mixture further comprises a binder, wherein the binder comprises a lignin, wherein the lignin comprises sodium lignosulfonate, calcium lignosulfonate, magnesium lignosulfonate, potassium lignosulfonate, or a combination thereof.

13. (canceled)

14. (canceled)

15. The dehydration membrane of claim 6, wherein the weight ratio of the additional crosslinker to the polycarboxylic acid is about 0 to about 1.

16. The dehydration membrane of claim 1, wherein the weight ratio of the crosslinker to the graphene oxide compound is about 0.5 to about 100.

17. The dehydration membrane of claim 1, wherein the composite or mixture further comprises an additive mixture comprising CaCl₂, LiCl, sodium polystyrene sulfonate, or a combination thereof.

18. The dehydration membrane of claim 17, wherein the CaCl₂) is about 0 wt % to about 35 wt % of the composite.

19. The dehydration membrane of claim 17, wherein the LiCl is about 0 wt % to about 10 wt % of the composite.

20. The dehydration membrane of claim 1, wherein the composite is in a layer having a thickness of about 100 nm to about 4000 nm.

21. The dehydration membrane of claim 1, having higher permeability for water vapor than a gas.

22. (canceled)

23. (canceled)

24. A method for dehydrating a gas comprising:
applying a first gas component comprising water vapor to the dehydration membrane of claim 1; and
allowing the water vapor to pass through the dehydration membrane and to be removed; and generating a second gas component that has lower water vapor content than the first gas component.

25. (canceled)

26. (canceled)

27. (canceled)
